(19) United States
(12) Patent Application Publication
(10) Pub. No.: US 2013/0032374 A1
(43) Pub. Date: Feb. 7, 2013

(54) POLYAMIDE-IMIDE RESIN INSULATING VARNISH AND METHOD OF MANUFACTURING THE SAME, INSULATED WIRE AND COIL

(71) Applicants: Takami USHIWATA, Hitachi (JP); Yuki HONDA, Hitachi (JP); Shuta NABESHIMA, Hitachi (JP); Hideyuki KIKUCHI, Hitachi (JP)

(72) Inventors: Takami USHIWATA, Hitachi (JP); Yuki HONDA, Hitachi (JP); Shuta NABESHIMA, Hitachi (JP); Hideyuki KIKUCHI, Hitachi (JP)

(73) Assignee: HITACHI CABLE, LTD., Tokyo (JP)

(21) Appl. No.: 13/564,514

(22) Filed: Aug. 1, 2012

(30) Foreign Application Priority Data
Aug. 2, 2011 (JP) 2011-169187

(51) Int. Cl. C09D 179/08; H01B 3/30

(52) U.S. Cl. 174/110 N; 524/590

(57) ABSTRACT

A polyamide-imide resin insulating varnish includes an amic acid-containing amide compound including a repeating unit represented by a general formula (1):

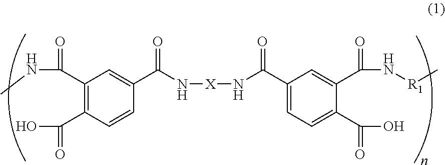

where X is a divalent organic group, and R₁ is a divalent organic group derived from a diamine.

The present application is based on Japanese patent application No. 2011-169187 filed on Aug. 2, 2011, the entire contents of which are incorporated herein by reference.

### BACKGROUND OF THE INVENTION

1. Field of the Invention

This invention relates to a polyamide-imide resin insulating varnish and a method of manufacturing the polyamide-imide resin insulating varnish, an insulated wire and a coil.

2. Description of the Related Art

Heretofore, an insulated wire that includes an insulation covering formed by using a polyamide-imide resin insulating varnish is known (for example, refer to JP-B-3496636). The polyamide-imide resin insulating varnish is a heat resistant polymeric resin that includes an amide group and an imide group at a rate of approximately 50/50, and is excellent in heat resistance, mechanical properties, hydrolysis resistance and the like.

The polyamide-imide resin insulating varnish is generally produced by a decarboxylation reaction between main two components of 4,4′-diphenylmethandiisocyanate (MDI) and trimellitic anhydride (TMA) in a polar solvent such as N-methyl-2-pyrroidone (NMP), N,N-dimethylformamide (DMF), N,N-dimethylacetamide (DMAC), dimethylimidazolidinone (DMI) and the like.

As a manufacturing method of the polyamide-imide resin insulating varnish, for example, an isocyanate method, an acid chloride method and the like are known, but from a viewpoint of manufacturing productivity, generally the isocyanate method is used.

In addition, for the purpose of improving characteristics of a polyamide-imide resin, a method is known, that is configured to react an aromatic diamine with an aromatic tricarboxylic anhydride in the presence of excessive acid of 50/100 to 80/100, and then synthesize a polyamide-imide resin by a diisocyanate component (for example, refer to JP-A-2009-161683).

On the other hand, the polyamide-imide resin has a disadvantage that it has a high dielectric constant so that partial discharge is easily generated when it is used for a material of insulation covering of insulated wire. The high dielectric constant is caused by an amide group and an imide group included in the polyamide-imide resin that have a large polarity, thus for the purpose of reducing the number of the amide group and the imide group per the repeating unit constituting the molecules of the polyamide-imide resin, a method is proposed, that is configured to use a monomer having a large molecular weight as the starting material of the polyamide-imide resin (for example, refer to JP-B-3496636).

### SUMMARY OF THE INVENTION

If the amide group and the imide group included in the polyamide-imide resin that have a large polarity are reduced in the number, the polyamide-imide resin insulating varnish is reduced in solubility in a solvent, so that solidification or precipitation of the resin is likely to be caused. If the solidification or precipitation of the polyamide-imide resin is caused, the polyamide-imide resin insulating varnish may be drastically reduced in coating workability.

As a countermeasure of this problem, it is considered that a nonvolatile component concentration of the resin is reduced, but if the nonvolatile component concentration of the resin is reduced, it is needed to increase the coating frequency of the varnish for obtaining an insulation covering that has a thickness similar to that of a conventional product, as a result, the production cost is increased. Further, in case that a polyamide-imide resin is used, that is configured to have the nonvolatile component concentration of the degree of not drastically increasing the production cost (not less than 20% by mass), it is needed to prevent the solidification or precipitation of the resin for not less than 30 minutes in an environment of a temperature of 30 degrees C. and a humidity of 50%.

Accordingly, it is an object of the invention to provide a polyamide-imide resin insulating varnish that is capable of forming an insulation covering that is excellent in partial discharge resistance, and is excellent in coating workability and cost performance, and a method of manufacturing the insulating varnish, an insulated wire formed by using the insulating varnish and a coil formed by using the insulated wire.

(1) According to one embodiment of the invention, a polyamide-imide resin insulating varnish comprises:

an amic acid-containing amide compound comprising a repeating unit represented by a general formula (1):

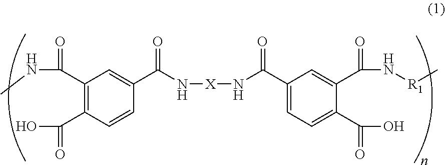

where X is a divalent organic group, and R₁ is a divalent organic group derived from a diamine.

In the above embodiment (1) of the invention, the following modifications and changes can be made.

(i) The amic acid-containing amide compound further comprises:

an amide compound represented by a general formula (2); and

a diamine component (C) alone or the diamine component (C) and a tetracarboxylic dianhydride (D),

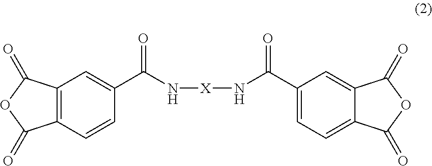

where X is the divalent organic group.

(ii) The R₁ is a site including a diamine component (C) and a tetracarboxylic dianhydride (D).

(iii) The whole or a part of the diamine component (C) and the tetracarboxylic dianhydride (D) is a compound containing not less than three benzene rings.

(2) According to another embodiment of the invention, a method of manufacturing a polyamide-imide resin insulating varnish comprises:

blending a tricarboxylic anhydride (A) and a diisocyanate component (B) so as to prepare a mixture; and

adding a diamine component (C) or the diamine component (C) and a tetracarboxylic dianhydride (D) to the mixture so as to react with each other to produce an amic acid-containing compound.

In the above embodiment (2) of the invention, the following modifications and changes can be made.

(iv) The blending of the tricarboxylic anhydride (A) and the diisocyanate component (B) is conducted to produce an amide compound represented by a general formula (2):

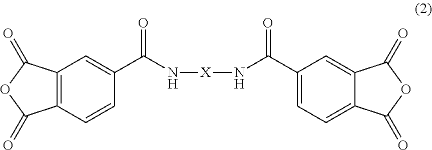

(3) According to another embodiment of the invention, an insulated wire comprises:

a conductor; and

an insulation covering formed on the conductor directly or via an other covering thereon,

wherein the insulation covering comprises the polyamide-imide resin insulating varnish according to the above embodiment (1).

(4) According to another embodiment of the invention, a coil comprises the insulated wire according to the above embodiment (3).

### EFFECTS OF THE INVENTION

According to one embodiment of the invention, a polyamide-imide resin insulating varnish can be provided that is capable of forming an insulation covering that is excellent in partial discharge resistance, and is excellent in coating workability and cost performance, and a method of manufacturing the insulating varnish, an insulated wire formed by using the insulating varnish and a coil formed by using the insulated wire.

### BRIEF DESCRIPTION OF THE DRAWINGS

The preferred embodiments according to the invention will be explained below referring to the drawing, wherein:

FIG. 1 is a cross-sectional view schematically showing an insulated wire according to an embodiment of the invention.

### DETAILED DESCRIPTION OF THE PREFERRED EMBODIMENTS

The polyamide-imide resin insulating varnish according to the embodiment can be formed into an insulation covering of an insulated wire by being coated and baked directly on a conductor such as copper or via the other covering thereon.

As the conductor of the insulated wire, a conductor that has various shapes such as a round wire, a rectangular wire can be used. In addition, the other film such as an adherent layer configured to improve adherence can be formed on and/or under the insulation covering, and a self-fusing layer can be also formed on the insulation covering.

In addition, the polyamide-imide resin insulating varnish may be formed into the insulation covering by being coated and baked on a member other than the conductor, such as a film and a substrate.

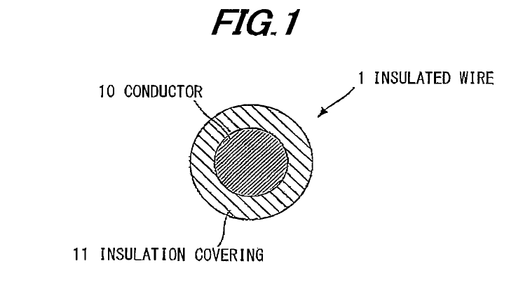

FIG. 1 is a cross-sectional view schematically showing the insulated wire according to the embodiment. The insulated wire according to the embodiment includes the conductor 10 and the insulation covering 11 that covers the conductor 10.

The polyamide-imide resin insulating varnish according to the embodiment includes an amide compound that has a chemical structure represented by a general formula (1) as a repeating unit, where, in the general formula (1), X is a divalent organic group, and R₁ is a divalent organic group derived from diamine.

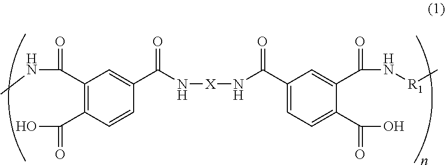

The repeating unit represented by a general formula (1) includes an amic acid that is to be imidized by heat other than an amide group. Where a diamine is used as R₁, the amic acid is formed in the amide compound. Due to the existence of the amic acid, the amide compound has a high solubility in a solvent. Consequently, if moisture in the atmosphere is absorbed in the polyamide-imide resin insulating varnish according to the embodiment, the polyamide-imide resin is drastically prevented from the solidification or precipitation in comparison with a case of the conventional polyamide-imide resin insulating varnish,

The polyamide-imide resin insulating varnish is coated and baked on the conductor 10 and the amic acid is dehydrated and imidized, thereby the insulation covering 11 comprised of the polyamide-imide resin can be obtained.

In addition, R₁ in the general formula (1) is a site comprised of a polyamic acid including a diamine component and a tetracarboxylic dianhydride. Where the polyamic acid site is thus incorporated into R₁, the amic acid component concentration in the amide compound can be further increased.

Therefore, the polyamide-imide resin can be more effectively prevented from the solidification or precipitation when the polyamide-imide resin insulating varnish absorbs moisture. In addition, after the polyamide-imide resin insulating varnish is coated and baked on the conductor 10, the amide component concentration and the imide component concentration in the insulation covering are lowered, and under the circumstances, the imide component concentration becomes relatively higher than the amide component concentration, thus the insulated wire can be more effectively prevented from partial discharge.

As the diamine component, 1,4-diaminobenzene (PPD), 1,3-diaminobenzene (MPD), 4,4′-diaminodiphenylmethane (DAM), 4,4′-diaminodiphenylether (ODA), 3,3′-dimethyl-4,4′-diaminobiphenyl, 2,2′-dimethyl-4,4′-diaminobiphenyl (m-TB), 2,2′-bis(trifluoromethyl)-4,4′-diaminobiphenyl, 4,4′-diaminobenzophenone, 3,3′-diaminobenzophenone, 4,4′-bis(4-aminophenyl)sulfide, 4,4′-diaminodiphenylsulfone, 4,4′-diaminobenzanilide, 9,9-bis(4-aminophenyl)fluorine (FDA), 1,4-bis (4-aminophenoxy)benzene (TPE-Q), 1,3-bis(4-aminophenoxy)benzene (TPE-R), 4,4′-bis(4-aminophenoxy)biphenyl, 2,2-bis(4-aminophenoxyphenyl)propane (BAPP), bis[4-(4-aminophenoxy)phenyl]sulfone (BAPS), 2,2-bis[4-(4-aminophenoxy)phenyl]hexafluoropropane (HFBAPS) and the like are used. In addition, hydrogenated compounds, halides, isomers and the like thereof can be also used alone or together.

As the tetracarboxylic dianhydride, pyromellitic dianhydride (PMDA), 3,3,4′,4,4′-benzophenone tetracarboxylic dianhydride (BTDA), 3,3′, 4,4′-diphenylsulfone tetracarboxylic dianhydride (DSDA), 4,4′-oxydiphthalic dianhydride (ODPA), 3,3,4′,4,4′-biphenyl tetracarboxylic dianhydride, 4,4-(2,2-hexafluoroisopropylidene) diphthalic anhydride (6FDA), 2,2-bis[4-(3,4-dicarboxyphenoxy)phenyl]propane dianhydride(BPADA) and the like can be used. In addition, if necessary, butane tetracarboxylic dianhydride, 5-(2,5-dioxotetrahydro-3-furanyl)-3-methyl-3-cyclohexene-1,2-dicarboxylic anhydride, or alicyclic tetracarboxylic dianhydride obtained by hydrogenation of the above-mentioned tetracarboxylic dianhydrides can be used together.

The whole or a part of the diamine component and the tetracarboxylic dianhydride used in the R₁ of the general formula (1) is a compound that contains not less than three benzene rings. In this case, the amide group and the imide group having a large polarity in the insulation covering formed from the polyamide-imide resin insulating varnish are reduced in the concentration, and the imide component concentration becomes relatively higher than the amide component concentration, thus the insulated film is reduced in the dielectric constant and the insulated wire can be more effectively prevented from partial discharge.

In addition, the amic acid-containing amide compound of the embodiment having a chemical structure represented by the general formula (1) is formed by, for example, the following method. First, a tricarboxylic anhydride (A) and a diisocyanate component (B) are blended with each other at a molar ratio of approximately 2:1 so as to prepare a mixture solution including an amide compound represented by a general formula (2):

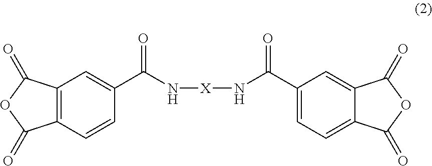

where X is a divalent organic group. Then, after the mixture solution is heated at 50 to 120 degrees C., a diamine component (C) alone or the diamine component (C) and a tetracarboxylic dianhydride (D) in combination are blended to the mixture solution including the amide compound represented by the general formula (2) so as to react each other to obtain the amic acid-containing amide compound represented by the general formula (1).

The amide compound as represented by a general formula (2) is derived from the tricarboxylic anhydride (A) and the diisocyanate component (B) and has an acid anhydride at the terminal.

In order to obtain the amide compound with the acid anhydride at the terminal from the tricarboxylic anhydride (A) and the diisocyanate component (B), it is preferable that the tricarboxylic anhydride (A) and the diisocyanate component (B) are blended in the range of 2:0.81 to 2:1.7 at a molar ratio. In addition, an isocyanate group of the diisocyanate component (B) is easily inactivated by moisture, thus it is more preferable that the diisocyanate component (B) is blended excessively (i.e., more than the theoretical blending molar ratio thereof) such that the tricarboxylic anhydride (A) and the diisocyanate component (B) are blended at a molar ratio of 2:1.05 to 2:1.7.

As the tricarboxylic anhydride (A), for example, trimellitic anhydride (TMA) is used. An aromatic tricarboxylic anhydride such as benzophenon tricarboxylic anhydride and the hydrogenated compound thereof other than TMA can be also used, but TMA is the most preferable as the tricarboxylic anhydride (A).

In addition, the X in the general formula (1) has a structure, for example, that a standalone skeleton derived from the diisocyanate component (B) and a skelton formed by that the tricarboxylic anhydride (A) and the diisocyanate component (B) are polymerized as an oligomer are mixed.

As the diisocyanate component (B), 4,4′-diphenylmethanediisocyanate (MDI), and other than MDI, a widely used aromatic diisocyanate such as tolylene diisocyanate (TDI), naphthalene diisocyanate, xylylene diisocyanate, biphenyl diisocyanate, diphenylsulfone diisocyanate, diphenylether diisocyanate, and isomers and multimers thereof are used. If necessary, aliphatic diisocyanates such as hexamethylene diisocyanate, isophorone diisocyanate, and dicyclohexylmethane diisocyanate, or alicyclic diisocyanates obtained by hydrogenation of the above-mentioned aromatic diisocyanates, and isomers thereof can be used alone or together.

In addition, as the diisocyanate component (B), for example, 2,2′-bis[4-(4-isocyanatephenoxy)phenyl]propane (BIPP), bis[4-(4-isocyanatephenoxy)phenyl]sulfone (BTPS), bis[4-(4-isocyanatephenoxy)phenyl]ether (BIM), fluorenediisocyanate 4,4′-bis(4-isocyanatephenoxy)biphenyl, 1,4-bis(4-isocyanate phenoxy)benzene, and isomers thereof are used. The manufacturing method of the diisocyanate component (B) is not particularly limited, but a method using phosgene is industrially the most appropriate and preferable.

Further, for the purpose of reducing dielectric constant of the polyimide-imide resin and improving transparency of the resin, if necessary, an alicyclic material can be used together, but it may cause a lowering of heat resistance, thus it is needed to consider the amount of blending and the chemical structure.

In order to synthesize the amide compound in the embodiment, a solvent that does not inhibit the synthesis reaction of the polyamide-imide resin can be used together, the solvent including, for example, N-methylpyrrolidone (NMP), γ-butyrolactone, N,N-dimethylacetamide (DMAC), N,N-dimethylformamide (DMF), dimethylimidazolidinone (DMI), cyclohexanone, methylcyclohexanone. In addition, These solvents can be used for dilution of the solution. For the dilution, aromatic allylbenzenes or the like can be used together. However, if it may lower the solubility of the polyamide-imide resin, it is necessary to consider its use.

It is preferable that the tricarboxylic anhydride (A) and the diisocyanate component (B) are reacted with each other at a temperature of 50 to 120 degrees C. If less than 50 degrees C., a reaction progress is slow, and if more than 120 degrees C., the diisocyanate component (B) reacts with both of a carboxylic acid and a carboxylic anhydride of the tricarboxylic anhydride (A), thus a rate of containing the amide compound that has an acid anhydride in the terminal is reduces.

### ADVANTAGES OF THE EMBODIMENT

The polyamide-imide resin insulating varnish according to the embodiment has the above-mentioned chemical structure, thereby even if the number of the amide group and the imide group per the repeating unit in the molecule is low, the resin has less incidence of the solidification or precipitation when moisture is absorbed. As a result, particularly, even in a period with high temperature and humidity such as summer season and rainy season, the resin can be effectively prevented from the solidification or precipitation, and equipment and time-consumption are not needed, so that cost increase can be prevented. Namely, the polyamide-imide resin insulating varnish according to the embodiment is capable of forming an insulation covering that is excellent in partial discharge resistance, and is excellent in coating workability and cost performance.

In addition, the polyamide-imide resin insulating varnish is used, thereby an insulated wire that has an insulation covering excellent in partial discharge resistance can be formed at a low cost. Further, the insulated wire like this can be used for, for example, forming a coil constituting an electric device such as a motor, an electric generator.

### EXAMPLES

Polyamide-imide resin insulating varnishes were manufactured by the methods shown in the following Examples 1 to 5 and Comparative Examples 1 to 3, and then the evaluation whether the resin was easily solidified or not at the time of moisture absorption was carried out to each polyamide-imide resin insulating varnish.

In addition, insulation coverings for an insulated wire were manufactured by using each polyamide-imide resin insulating varnish, and a partial discharge inception voltage of the insulated wire was measured.

Manufacturing of Polyamide-Imide Resin Insulating Varnish

In the following Examples 1 to 5, similarly to the above-mentioned embodiment, polyamide-imide resin insulating varnishes were manufactured by using the method of as a first step synthesis, blending a tricarboxylic anhydride (A) and a diisocyanate component (B) so as to prepare an amide compound, and as a second step synthesis, adding a diamine component (C) alone or the diamine component (C) and a tetracarboxylic dianhydride (D) in combination, to the amide compound so as to react with each other and prepare an amic acid-containing compound. On the other hand, in Comparative Examples 1 to 3, polyamide-imide resin insulating varnishes were manufactured by different processes from the method of the embodiment.

### Example 1

As the first step synthesis, 192 g (1.0 mole) of trimellitic anhydride as the tricarboxylic anhydride (A) in the embodiment, 175.2 g (0.7 mole) of 4,4′-diphenylmethandiisocyanate as the diisocyanate component (B) in the embodiment, and 600 g of N-methyl-2-pyrroidone as a solvent were provided into a flask, and after the mixture solution was stirred at 80 degrees C. for 2 hours, it was stirred at 100 degrees C. for 1 hours. As the flask, a flask with a stirrer, a nitrogen inlet pipe and a thermometer was used. After that, the r was cooled to room temperature while a nitrogen atmosphere was maintained.

As the second step synthesis, 100 g (0.5 mole) of 4,4′-diaminodiphenylether as the diamine component (C) in the embodiment were provided into the reaction solution, and 801.6 g of N-methyl-2-pyrroidone were added thereto, and stirring was carried out at room temperature during all night, and a polyamide-imide resin insulating varnish including an amic acid-containing amide compound was obtained.

### Example 2

As the first step synthesis, 192 g (1.0 mole) of trimellitic anhydride as the tricarboxylic anhydride (A) in the embodiment, 175.2 g (0.7 mole) of 4,4′-diphenylmethandiisocyanate as the diisocyanate component (B) in the embodiment, and 600 g of N-methyl-2-pyrroidone as a solvent were provided into a flask, and after the mixture solution was stirred at 80 degrees C. for 2 hours, it was stirred at 100 degrees C. for 1 hours. After that, the reaction solution was cooled to room temperature while a nitrogen atmosphere was maintained.

As the second step synthesis, 205.1 g (0.5 mole) of 2,2-bis(4-aminophenoxyphenyl)propane as the diamine component (C) in the embodiment were provided into the reaction solution, and 1116.9 g of N-methyl-2-pyrroid one were added thereto, and stirring was carried out at room temperature during all night, and a polyamide-imide resin insulating varnish including an amic acid-containing amide compound was obtained.

### Example 3

As the first step synthesis, 192 g (1.0 mole) of trimellitic anhydride as the tricarboxylic anhydride (A) in the embodiment, 175.2 g (0.7 mole) of 4,4′-diphenylmethandiisocyanate as the diisocyanate component (B) in the embodiment, and 600 g of N-methyl-2-pyrroidone as a solvent were provided into a flask, and after the mixture solution was stirred at 80 degrees C. for 2 hours, it was stirred at 100 degrees C. for 1 hours. After that, the reaction solution was cooled to room temperature while a nitrogen atmosphere was maintained.

As the second step synthesis, 156 g (0.5 mole) of 4,4′-oxydiphthalic dianhydride as the tetracarboxylic dianhydride (D) in the embodiment, 410 g (1.0 mole) of 2,2-bis(4-aminophenoxyphenyl)propane as the diamine component (C) in the embodiment were provided into the reaction solution, and 2199.6 g of N-methyl-2-pyrroidone were added thereto, and stirring was carried out at room temperature during all night, and a polyamide-imide resin insulating varnish including an amic acid-containing amide compound was obtained.

### Example 4

As the first step synthesis, 19.2 g (0.1 mole) of trimellitic anhydride as the tricarboxylic anhydride (A) in the embodiment, 175.2 g (0.7 mole) of 4,4′-diphenylmethandiisocyanate as the diisocyanate component (B) in the embodiment, and 200 g of N-methyl-2-pyrroidone as a solvent were provided into a flask, and after the mixture solution was stirred at 80 degrees C. for 2 hours, it was stirred at 100 degrees C. for 1 hours. After that, the reaction solution was cooled to room temperature while a nitrogen atmosphere was maintained.

As the second step synthesis, 234 g (0.45 mole) of 2,2-bis[4-(3,4-dicarboxyphenoxy)phenyl]propane as the tetracarboxylic dianhydride (D) in the embodiment, 205.1 g (0.5 mole) of 2,2-bis(4-aminophenoxyphenyl)propane as the diamine component (C) in the embodiment were provided into the reaction solution, and 1227.4 g of N-methyl-2-pyrroidone were added thereto, and stirring was carried out at room temperature during all night, and a polyamide-imide resin insulating varnish including an amic acid-containing amide compound was obtained.

### Example 5

As the first step synthesis, 19.2 g (0.1 mole) of trimellitic anhydride as the tricarboxylic anhydride (A) in the embodiment, 17.5 g (0.07 mole) of 4,4′-diphenylmethandiisocyanate as the diisocyanate component (B) in the embodiment, and 199.6 g of N-methyl-2-pyrroidone as a solvent were provided into a flask, and after the mixture solution was stirred at 80 degrees C. for 2 hours, it was stirred at 100 degrees C. for 1 hours. After that, the reaction solution was cooled to room temperature while a nitrogen atmosphere was maintained.

As the second step synthesis, 468 g (0.9 mole) of 2,2-bis[4-(3,4-dicarboxyphenoxy)phenyl]propane as the tetracarboxylic dianhydride (D) in the embodiment, 292.3 g (0.713 mole) of 2,2-bis(4-aminophenoxyphenyl)propane and 82.7 g (0.238 mole) of 9,9-bis(4-aminophenyl)fluorine as the diamine component (C) in the embodiment were provided into the reaction solution, and 2042.5 g of N-methyl-2-pyrroidone were added thereto, and stirring was carried out at room temperature during all night, and a polyamide-imide resin insulating varnish including an antic acid-containing amide compound was obtained.

### Comparative Example 1

192.1 g (1.0 mole) of trimellitic anhydride as the tricarboxylic anhydride (A), 250.0 g (1.0 mole) of 4,4′-diphenylmethandiisocyanate as the diisocyanate component (B), and 1300 g of N-methyl-2-pyrroidone as a solvent were provided into a flask, and a synthesis reaction was carried out at 140 degrees C. After 1 hour, benzyl alcohol of approximately 2% relative to an acid component was added, and stirring was carried out for 30 minutes, and a polyamide-imide resin insulating varnish was obtained.

### Comparative Example 2

As the first step synthesis, 215.4 g (0.53 mole) of 2,2-bis(4-aminophenoxyphenyl)propane as the diamine component (C), 182.5 g (0.95 mole) of trimellitic anhydride as the tricarboxylic anhydride (A), 15.6 g (0.05 mole) of 4,4′-oxydiphthalic dianhydride as the tetracarboxylic dianhydride (D) and 853 g of N-methyl-2-pyrroidone as a solvent were provided into a flask, and a synthesis reaction was carried out at 180 degrees C. while water was discharged outside the reaction system. After that, the reaction solution was cooled to 60 degrees C. while a nitrogen atmosphere was maintained.

As the second step synthesis, 118.9 g (0.48 mole) of 4,4′-diphenylmethandiisocyanate as the diisocyanate component (B) was provided into the reaction solution, and a synthesis reaction was carried out at 140 degrees C. After 1 hour, benzyl alcohol of approximately 2% relative to an acid component and 366 g of N-methyl-2-pyrroidone were added, stirring was carried out for 30 minutes, and a polyamide-imide resin insulating varnish was obtained.

### Comparative Example 3

As the first step synthesis, 291.1 g (0.71 mole) of 2,2-bis(4-aminophenoxyphenyl)propane as the diamine component (C), 111.4 g (0.58 mole) of trimellitic anhydride as the tricarboxylic anhydride (A), 150.4 g (0.42 mole) of 3,3′, 4,4′-diphenylsulfone tetracarboxylic dianhydride as the tetracarboxylic dianhydride (D) and 1200 g of N-methyl-2-pyrroidone as a solvent were provided into a flask, and a synthesis reaction was carried out at 180 degrees C. while water was discharged outside the reaction system. After that, the reaction solution was cooled to 60 degrees C. while a nitrogen atmosphere was maintained.

As the second step synthesis, 72.5 g (0.29 mole) of 4,4′-diphenylmethandiisocyanate as the diisocyanate component (B) was provided into the reaction solution, and a synthesis reaction was carried out at 140 degrees C. After 1 hour, benzyl alcohol of approximately 2% relative to an acid component and 600 g of N-methyl-2-pyrroidone were added, stirring was carried out for 30 minutes, and a polyamide-imide resin insulating varnish was obtained.

Evaluation of Solidification Characteristic

The polyamide-imide resin insulating varnishes manufactured by the methods shown in the above-mentioned Examples 1 to 5 and Comparative Examples 1 to 3 were respectively mounted on an aluminum pan, and were stored in a constant temperature and humidity chamber of 30 degrees C. and 50% RH for 30 minutes. After that, the degree of solidification of the polyamide-imide resin insulating varnishes were respectively observed and evaluated by a visual inspection.

Measurement of Partial Discharge Inception Voltage

Each of the polyamide-imide resin insulating varnishes was coated and baked on a conductor having a diameter of 0.8 min, an insulation covering having a film thickness of 40 μm was formed, and an insulated wire was obtained. Next, the insulated wire was cut out by 500 mm and a sample of a twist pair was fabricated. The insulation covering was separated from the end portion of the sample of the twist pair obtained to the position located at 10 mm from the end portion, so as to form a terminal treatment part.

After that, the sample was disposed in a constant temperature and humidity chamber of 25 degrees C. and 50% RH and an electrode was connected to the terminal treatment part, and voltage of 50 Hz was raised at a rate of 10 to 30 V/S by using a partial discharge automatic test equipment. The voltage at the time when discharge of 10 pC occurred 50 times in the sample of the twist pair was measured. This was repeated three times and the average of the respective values was determined as the partial discharge inception voltage.

The evaluation and measurement result of Examples 1 to 5 are shown in Table 1 and the evaluation and measurement result of Comparative Examples 1 to 3 are shown in Table 2. In the column of “judgment of solidification test” of Tables 1 and 2, the mark (◯) shows a case that the varnish remains transparent and the mark (X) shows a case that the varnish is solidified and whitened.

TABLE 1
unit: gram (mole in parentheses)

| | | | | Example 1 | Example 2 | Example 3 | Example 4 | Example 5 |
|---|---|---|---|---|---|---|---|---|
| Used amount of | Diamine | Diamine (C) | BAPP | — | 205.1 | 410 | 205.1 | 292.3 |
| starting materials | component | | (MW: 410.2) | | (0.5) | (1.0) | (0.5) | (0.713) |
| of | | | ODA | 100.0 | — | — | — | — |
| polyamide-imide | | | (MW: 200) | (0.5) | | | | |
| resin | | | FDA | — | — | — | — | 82.7 |
| | | | (MW: 348) | | | | | (0.238) |
| | Acid | Tricarboxylic | TMA | 192 | 192 | 192 | 19.2 | 19.2 |
| | component | anhydride (A) | (MW: 192.1) | (1.0) | (1.0) | (1.0) | (0.1) | (0.1) |
| | | Tetracarboxylic | ODPA | — | — | 156 | — | — |
| | | dianhydride | (MW: 312) | | | (0.5) | | |
| | | (D) | BPADA | — | — | — | 234 | 468.1 |
| | | | (MW: 520) | | | | (0.45) | (0.9) |
| | Isocyanate | Diisocyanate | MDI | 175.2 | 175.2 | 175.2 | 17.5 | 17.5 |
| | component | component (B) | (MW: 250) | (0.7) | (0.7) | (0.7) | (0.07) | (0.07) |

| | | | | | | |
|---|---|---|---|---|---|---|
| Characteristic of | Nonvolatile component concentration (wt %) | 27 | 27 | 27 | 27 | 27 |
| polyamide-imide | Evaluation in solidification test | ◯ | ◯ | ◯ | ◯ | ◯ |
| resin varnish | | | | | | |
| Characteristic of | Total concentration of amide group and | 31.8 | 24.5 | 22.8 | 16.6 | 16.4 |
| insulated wire | imide group (%) | | | | | |
| | Partial discharge inception voltage (Vp) | 930 | 950 | 1020 | 1050 | 1060 |
| | Film thickness (μm) | 40 | 40 | 40 | 40 | 40 |

TABLE 2
unit: gram (mole in parentheses)

| | | | | Comparative | Comparative | Comparative |
|---|---|---|---|---|---|---|
| | | | | Example 1 | Example 2 | Example 3 |
| Used amount of | Diamine | Diamine (C) | BAPP | — | 205.1 | 410.2 |
| starting materials | component | | (MW: 410.2) | | (0.5) | (1.0) |
| of | Acid | Tricarboxylic | TMA | 192.1 | 192 | 192 |
| polyamide-imide | component | anhydride (A) | (MW: 192.1) | (1.0) | (1.0) | (1.0) |
| resin | | Tetracarboxylic | ODPA | — | — | 156 |
| | | dianhydride | (MW: 312) | | | (0.5) |
| | | (D) | | | | |
| | Isocyanate | Diisocyanate | MDI | 250.0 | 125 | 125 |
| | component | component (B) | (MW: 250) | (1.0) | (0.5) | (0.5) |

| | | | | |
|---|---|---|---|---|
| Characteristic of | Nonvolatile component concentration (wt %) | 27 | 27 | 27 |
| polyamide-imide | Evaluation in solidification test | X | X | X |
| resin varnish | | | | |
| Characteristic of | Total concentration of amide group and | 31.8 | 24.5 | 22.8 |
| insulated wire | imide group (%) | | | |
| | Partial discharge inception voltage (Vp) | 788 | 940 | 955 |
| | Film thickness (μm) | 40 | 40 | 40 |

Table 1 shows that the polyamide-imide resin insulating varnishes of Examples 1 to 5 were prevented from the solidification of the resin at the time of absorption of moisture. On the other hand, Table 2 shows that the polyamide-imide resin insulating varnishes of Comparative Examples 1 to 3 caused the solidification of the resin at the time of absorption of moisture. This is considered to be due to the fact that the polyamide-imide resin insulating varnishes of Comparative Examples 1 to 3 were manufactured by processes different from the embodiment, so as to have a chemical structure different from Examples 1 to 5.

In addition, in order to exhibit the polarity of the varnishes of Examples 1 to 5 and Comparative Examples 1 to 3, Tables 1 and 2 show the total concentration of an amide group and an imide group that are contained in each varnish and have a large polarity. The total concentration of the amide group and the imide group is expressed in percentage as a ratio of the sum molecular weight of the amide group (—CO—NH—, molecular weight=43) and the imide group (—CO—N—CO—, molecular weight=70) relative to the total molecular weight in the repeating unit represented by the general formula (1).

Both of the varnishes of Examples 1 to 5 and the varnishes of Comparative Examples 1 to 3 have the relatively low concentration of the amide group and the imide group. For this reason, the insulated wires formed by using the varnishes of Comparative Examples 1 to 3 have values of partial discharge inception voltage close to those of the insulated wires formed by using the varnishes of Examples 1 to 5. However, the varnishes of Comparative Examples 1 to 3 are likely to cause the solidification of the resin at the time of moisture absorption, thus the varnishes have a bad coating workability to the conductor, so as to increase the production cost of the insulated wire, in case of providing sufficient partial discharge resistance for the insulated wire.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A polyamide-imide resin insulating varnish, comprising:
an amic acid-containing amide compound comprising a repeating unit represented by a general formula (1): 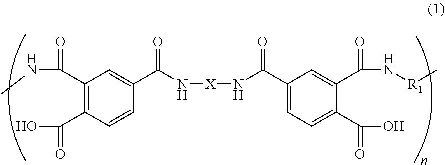
where X is a divalent organic group, and R₁ is a divalent organic group derived from a diamine.

2. The polyamide-imide resin insulating varnish according to claim 1, wherein the amic acid-containing amide compound further comprises:
an amide compound represented by a general formula (2); and
a diamine component (C) alone or the diamine component (C) and a tetracarboxylic dianhydride (D), 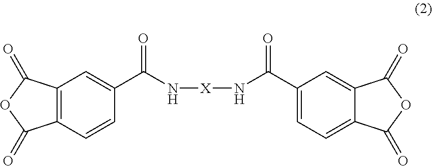
where X is the divalent organic group.

3. The polyamide-imide resin insulating varnish according to claim 1, wherein the R₁ is a site including a diamine component (C) and a tetracarboxylic dianhydride (D).

4. The polyamide-imide resin insulating varnish according to claim 3, wherein the whole or a part of the diamine component (C) and the tetracarboxylic dianhydride (D) is a compound containing not less than three benzene rings.

5. A method of manufacturing a polyamide-imide resin insulating varnish, comprising:
blending a tricarboxylic anhydride (A) and a diisocyanate component (B) so as to prepare a mixture; and
adding a diamine component (C) or the diamine component (C) and a tetracarboxylic dianhydride (D) to the mixture so as to react with each other to produce an amic acid-containing compound.

6. The method according to claim 5, wherein the blending of the tricarboxylic anhydride (A) and the diisocyanate component (B) is conducted to produce an amide compound represented by a general formula (2):

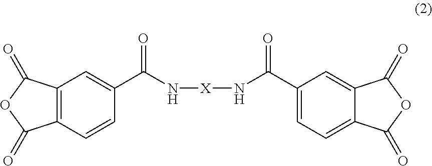

7. An insulated wire, comprising:
a conductor; and
an insulation covering formed on the conductor directly or via an other covering thereon,
wherein the insulation covering comprises the polyamide-imide resin insulating varnish according to claim 1.

8. A coil comprising the insulated wire according to claim 7.
